(19) United States
(12) Patent Application Publication
(10) Pub. No.: US 2019/0205867 A1
(43) Pub. Date: Jul. 4, 2019

(54) WALLET PROVIDER DATA PROCESS FOR FACILITATING DIGITIZATION OF PAYMENT ACCOUNT

(71) Applicant: MasterCard International Incorporated, Purchase, NY (US)

(72) Inventors: Cristian Radu, Beauvechain (BE); Anthony Steven Cooper, O'Fallon, MO (US)

(21) Appl. No.: 15/861,144

(22) Filed: Jan. 3, 2018

(51) Int. Cl. G06Q 20/36; G06Q 20/38; G06Q 20/40

(52) U.S. Cl. CPC G06Q 20/3674; G06Q 20/4018; G06Q 20/3825

(57) ABSTRACT

Systems and methods are disclosed that utilize a flexible data structure to facilitate a consumer payment account digitization process. In an embodiment, a Trusted Services Provider (TSP) computer receives a digitization request associated with a consumer payment account from a registered Wallet Provider (WP) computer, and then generates a WP backpack data package by combining WP identification data, WP load data, and data resulting from a combination of WP-specific data and a WP-specific data mask. The TSP computer then generates an authorizeService application program interface (API) request by combining the WP backpack data package with TSP data elements, and transmits the authorize service API request to an Issuer FI computer for digitization authorization processing.

### FIELD OF THE DISCLOSURE

Embodiments disclosed herein generally relate to digitization of consumer payment accounts by Token Services Provider (TSP) systems. More specifically, disclosed herein are systems and methods which utilize a flexible data structure to facilitate a consumer payment account digitization process while also providing increased security as compared to conventional processes.

### BACKGROUND

Portable electronic devices, such as smartphones, tablet computers, digital music players and the like, have been developed that include desirable functionality and thus the number of mobile device users and/or owners keeps growing. These mobile devices can store all types of information, and can perform many different types of functions for users. For example, global positioning system (GPS) applications, mobile office products, messaging systems, video cameras, and even compass functionality have been incorporated into mobile devices, which has led to their widespread adoption for both business and personal use. The overall popularity of such mobile devices, especially smartphones, has led to the development of mobile wallet applications and/or processes for conducting financial transactions, for example, transmitting payment for goods or services from a payer (a consumer or payment card account holder or cardholder) to a payee (or recipient, such as a merchant or another cardholder).

Consumers who wish to enjoy mobile wallet functionality can have their mobile devices provisioned with payment card account information obtained by, for example a Token Services Provider (TSP) computer from an Issuer financial institution (FI) directly onto a secure element (SE) of the consumer's mobile device (which may be equipped with a Near Field Communication (NFC) chipset). However, other implementations have been developed wherein the consumer's payment card account information resides in a server computer, which information can then be utilized, for example, to engage in remote transactions.

Typical payment credential provisioning processes can require multiple messages between a TSP computer system, a third-party wallet provider (WP), and an Issuer FI. The secure element (SE) may be a smart card chip capable of storing multiple applications and/or sensitive data (such as a consumer's payment account data), and that is not easily accessed by external parties. NFC technology is commonly used for contactless short-range (e.g., a few centimeters) communications (based on radio frequency identification (RFID) standards) between electronic devices, such as a between a consumer's smartphone and a merchant's NFC payment card reader. Thus, consumer mobile devices may utilize a mobile wallet application that, like a conventional physical wallet, may include one or more payment cards (e.g., credit cards, debit cards, prepaid cards), member cards, transportation cards, loyalty cards, and the like.

Accordingly, user financial credentials (such as a consumer's Primary Account Number (PAN) of a financial account, tokens derived from the PAN, an expiration date, and the like) may be provisioned onto the users' mobile device. Once these financial credentials have been provisioned, the consumer may use his or her NFC-enabled mobile device, to transact with (e.g., transfer information, make payments to) another NFC-enabled device by placing the devices near each other. Additionally, mobile devices with provisioned financial accounts may also be used to perform transactions with remote systems (e.g., such as a website of a merchant), for example, by using other wireless protocols such as via a cellular or wireless network.

The benefits from integrating wallet functionality into mobile devices are significant and are still being developed. However, the prevailing technology still lacks effective processes and means to flexibly and efficiently provide Issuer financial institutions (FIs) with required data elements from Wallet Providers (WPs) that enable the issuer FIs to make effective risk management decisions. In addition, existing decline reason code processing, which occurs when an Issuer FI decides to refuse digitization of a consumer's payment card account, are often too vague in the context of guiding consumer behavior. Thus, embodiments disclosed herein address these and other problems, individually and collectively.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate exemplary embodiments and which are not necessarily drawn to scale, wherein:

FIG. 1 is a block diagram illustrating a provisioning marketplace system in which disclosed processes may be applied in accordance with embodiments of the disclosure;

FIG. 2 is a flow diagram illustrating a process for dynamically configuring an authorizeService request and an authorizeService response in accordance with embodiments of the disclosure;

FIG. 3A is a functional block diagram illustrating formation of a WP backpack data package in accordance with embodiments of the disclosure;

FIG. 3B is a functional block diagram illustrating formation of an Issuer backpack data package in accordance with embodiments of the disclosure;

FIG. 4 is a block diagram illustrating an example of a TSP computer system which may be utilized in accordance with aspects of the present disclosure; and

FIG. 5 is a flowchart illustrating a payment account digitization process according to some embodiments of the disclosure.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms are not intended to be limiting, but rather are used for convenience and ease of exposition. For example, as used herein, the term “cardholder” may be used interchangeably with the term “consumer” or “user” and are used herein to refer to a consumer, person, individual, business or other entity that owns (or is authorized to use) a financial account such as a payment card account (for example, a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as Mastercard International Incorporated, or a similar system. In some embodiments, the term “payment card system” may be limited to systems in which member financial institutions (such as banks) issue payment card accounts to individuals, businesses and/or other entities or organizations.

In addition, as used herein, a “mobile device” may comprise any electronic and/or communication device that may be transported and operated by a user, which may also provide remote communication capabilities with resources via one or more networks. Examples of mobile devices include mobile telephones (e.g., cellular phones and/or smartphone), personal digital assistants (PDAs), tablet computers, laptop computers (e.g., netbooks), personal music players, hand-held electronic reading devices, wearable computing devices, and the like.

As also used herein, “identification information” may include any suitable information and/or data associated with an account (for example, a payment card account and/or a mobile device associated with the account). Such identification information may be directly related to the account or may be derived from information related to the account. Examples of account information may include a PAN (Primary Account Number), or a Token generated or derived from a PAN for a given mobile device and/or server computer on a certain interaction channel (which may be a secure channel). Other types of identification information may include, but are not limited to, a user name, an expiration date, a CVV (Card Verification Value), a dCVV (Dynamic Card Verification Value), a CVV2 (Card Verification Value 2), a CVC3 card verification value, and the like.

In general, and for the purpose of introducing concepts of novel embodiments described herein, described are Token Services Provider (TSP) systems and processes that facilitate and increase the security of the consumer account digitization process for Issuer financial institutions (FIs), while also providing a more user-friendly process for the consumers of digital Wallet Providers (WPs) services. In some embodiments, a TSP computer system permits a digital wallet provisioning process to occur between WPs and Issuer FIs without having any interruptions due to problems with data requirements and/or data mismatches. More specifically, in accordance with embodiments described herein, a TSP computer system receives WP-specific data elements (DEs) and load data, and then utilizes a WP-specific data mask (wherein the data mask is provided by the Issuer FI) while generating an authorizeService Application Programming Interface (API) request. As a result, the authorizeService API request includes only those WP-specific data elements needed and/or required by the Issuer FI to make a digitization decision. The authorizeService API request is then transmitted to the Issuer FI. The method may also include the TSP computer system processing the Issuer FI's digitization decision communicated within the authorizeService API response, and then transmitting a digitization response to the WP that may include one or more WP-specific reason codes.

In embodiments disclosed herein, the WP-specific data mask is the means by which an Issuer FI synchronizes its' web service implementation efforts with the increased offer(s) of one or more Wallet Providers (WPs). For example, a specific data element “x” may be provided with WP-specific data by a first WP, and a first Issuer FI may not be interested in that data element “x” with regard to the first Issuer's security policies. Thus, the first Issuer FI blocks data element “x” with its' WP-specific data mask. However, the specific data element “x” may be of high interest to a second Issuer FI for use in implementing its' security policies, and thus data element “x” would not be blocked by the second Issuer FI's WP-specific data mask. In addition, the first Issuer FI may have an interest in utilizing the data element “x” of the WP-specific data in the future, but may not yet be able to use it because the first Issuer FI has not yet implemented the necessary infrastructure and/or may not yet have the bandwidth available. In this situation, when the necessary infrastructure is put into place and/or bandwidth becomes available, then the first Issuer FI can change its' WP-specific data mask to accept data element “x” to implement its' security policy.

In implementations disclosed herein, the data set of the TSP system is advantageously enlarged because it is no longer restricted to only the data elements that are common in all of the data sets of the Wallet Providers (WPs). In addition, pre-digitization authorization messages having new data elements that are specific to each WP can now be utilized. For example, an implementation of the Mastercard Digital Enablement Services (MDES) data set utilizes a pre-established data set that is based on the commonalities between data of all of the WPs. However, through use of the processes disclosed herein, the MDES data set will be enlarged and can also include new data elements specific to each WP. Such operation helps Issuer FIs make improved risk management decisions (because, for example, a first Issuer FI may be able to utilize a new WP-specific data element that a second Issuer FI cannot use or cannot yet handle), and which also serves to differentiate between the relative “intelligence” of the WPs. Thus, an Issuer FI may favor a first WP's product as having more appeal than a second WP's product (due to the benefit(s) of the specific data elements of the first WP).

In addition, embodiments described herein may provide enriched Decline Reason Codes (DRCs) which can be returned by an Issuer FI in the response to a digitization request when the digitization request is denied or declined. Such enriched DRCs can be useful because the requesting WP may use a DRC to guide one or more consumers regarding his or her behavior (for example, spending behavior) which was the cause (indicated by the DRC) for the refusal by the Issuer FI to digitize one of her or his payment card accounts. In fact, each Issuer FI desires the ability to provide better information to guide consumers when digitization of an account is refused, so that the consumer can be educated concerning why digitization was not allowed (so that the consumer can change his or her behavior in order to obtain digitization of his or her account in the future). In addition, Issuer FIs would like to inform the WP about what action or actions to take if the consumer insists on having one or more payment card accounts digitized (for example, the WP may receive a response code indicating why a particular digitization request was declined, and/or may receive suggested actions for the WP to take when defining reason codes).

The disclosed methods and processes result in increased adherence and/or use by the Issuer FIs and the WPs of the TSP computer system. Beneficially, disclosed embodiments permit increased security to be achieved by taking advantage of new technological advances that become available as mobile device technology advances (for example, when new or additional sensor(s) and associated sensor data is developed that can be used to authenticate a consumer), and by enabling the TSP computer system to provide more and/or additional information and/or data to Issuer FIs (as reported by the Wallet Providers) during the actual provisioning process (e.g., reporting on Fraud Reaction and Detection (FRD) signals from channels other than digital payment channels). In addition, processes disclosed herein advantageously provide increased security and usability improvements while minimizing TSP computer system development costs related to updates and/or various customizations needed related to data requirements demanded by, or provided by, one or more of the WPs.

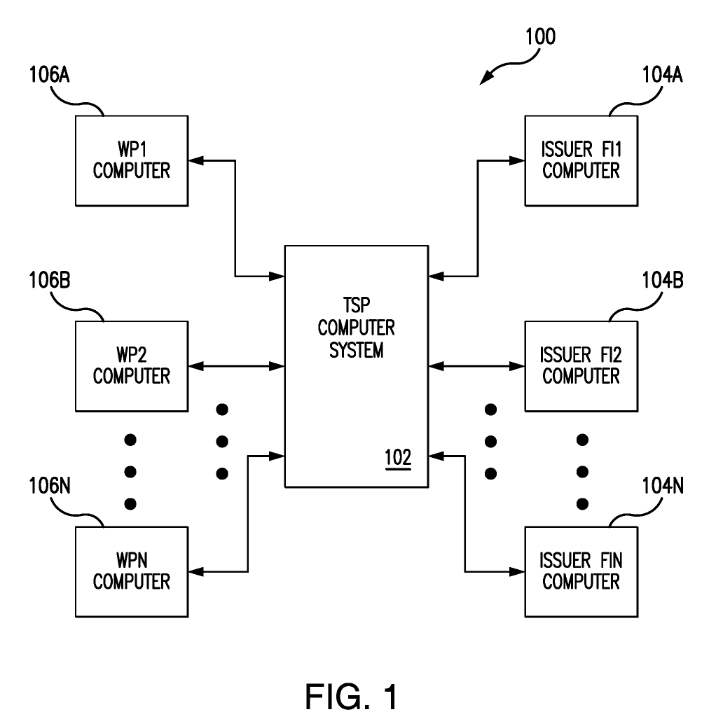

FIG. 1 is a block diagram illustrating a provisioning marketplace system 100 in which teachings of the present disclosure may be applied. The provisioning marketplace system 100 includes a Trusted Services Provider (TSP) computer 102 that provides services (and that bridges) to a plurality of Issuer financial institution (FI) computers 104A, 104B to 104N and to a plurality of Wallet Provider (WPs) computers 106A, 106B to 106N (which could also be called Token Requestor (TR) computers). The TSP computer 102 is operable to digitize payment card account credentials which enable, for example, a consumer's mobile device to perform payments via existing contactless point-of-sale systems and via new remote payment use cases (such as by utilizing in-app mobile device payments). Such digitization service-enhanced, device-based payment methods are designed to offer consumers simpler checkout and payment experiences, and to provide increased payment security. It should be understood, however that digitization may involve other entities and/or devices other than a mobile device, for example, tokenization may involve a Wallet Server and/or a Merchant Server (and in this case no mobile device is involved). In addition, other types of authorization calls to an Issuer FI computer may be involved (instead of authorizeService API requests).

Referring again to the example provisioning marketplace system 100 of FIG. 1, the Issuer FI computers 104A, 104B to 104N are each associated with a particular Issuer FI (such as a bank). Each such Issuer FI is willing to have their cardholders' payment card accounts digitized in as many digital wallets as possible to increase revenues associated with an increase in use of those financial accounts by their cardholders. The Wallet Provider (WP) computers 106A, 106B to 106N are each associated with a Wallet Provider, wherein each such WP is also interested in providing their customers (consumers) with multiple payment means digitized into their mobile devices. After provisioning, a consumer can then utilize his or her mobile device (such as a smartphone) to trigger purchase transactions (retail payments) in both face-to-face transactions and e-commerce transactions with the digital wallet (which can include one or more digitized payment card accounts) instead of using a plastic payment card. Wallet Providers (WPs) (or Token Requestors (TRs)) also benefit from an increase in the use of digital wallets by consumers because the WP receives increased service fees from the Issuer FIs, thus increasing their revenues (and profits). Issuer FIs also benefit by the increase in cardholder purchase transaction activity, for example, by being able to charge fees and/or charge interest on the balance of any money owed by account holders in their digitized payment accounts.

In some implementations, the Issuer FIs and the WPs (or TRs), which propose digital cards for payment transactions, first enroll with the TSP computer system 102 so that their interactions with both the TSP computer system 102 and with other marketplace partners are well defined. Such operation allows the marketplace partners to “adhere to the market,” and is referred to as “onboarding.” In embodiments described herein, when an Issuer FI performs onboarding of an account range (for example, for a range of consumer payment card accounts that may be digitized upon cardholder request) in the TSP computer system 102 for a WP (for example, WP2 106B), then that Issuer FI must observe the requirements of both the TSP computer system 102 and of the WP2 106B concerning the type(s) of pre-digitization messages and their data elements. Thus, during the digitization of payment card accounts, the TSP computer system 102 transmits pre-digitization messages to, for example, the Issuer FI2 computer 104B to check whether or not Issuer FI2 will agree to issue a token corresponding to that payment card account on the consumer's mobile device and/or the TSP computer system 102, as proposed by the WP2 computer 106B.

In some embodiments, any particular Issuer FI may choose the type of network on which it receives the pre-digitization authorization messages from the TSP computer system 102, and on which it provides authorization responses for creating the token. For example, the Issuer FI may choose to utilize Mastercard 01X0/02X0 network messages (e.g., Tokenization Authorization Request/Response, TA, and the like), or may choose to use web services exchanged with application programming interfaces (APIs) via a secure channel over the Internet (e.g., authorizeService API request and authorizeService API response messages), or may choose to utilize a combination of these approaches, or some other network.

In some embodiments, the “MasterCard Digital Enablement Service” (MDES) platform, which has been developed by MasterCard International Incorporated (the assignee of the present application), may be modified and/or configured for operating in accordance with the processes disclosed herein. The MDES platform provides a suite of on-behalf-of (OBO) services that support the management, generation, and provisioning of digital payment credentials (such as tokens) into mobile devices. For example, the MDES platform generates and manages tokens, and can provide an EMV-like version of the consumer's payment card account number. (“EMV” stands for Europay, MasterCard, Visa, and denotes a global standard for chip-based debit card account and credit card account transactions which ensures security and global acceptance of such accounts.) Thus, digital transactions include cryptograms, dynamic data and the like for added security. The MDES platform therefore enables simpler, more secure digital payment experiences than those offered in the past, and was developed to facilitate the financial industry transition from consumer account credentials stored on traditional payment cards, to digital credentials provisioned into mobile devices.

In some implementations, the MDES application programming interface (API) includes a minimal set of data elements that a WP must provide to Issuer FIs to enable an Issuer FI to run their risk evaluation processes with regard to digitizing a payment card account. The Mastercard Data Elements (MCDE) defines the minimal set of data elements that the MDES expects to receive from the WP for forwarding to an Issuer FI during a digitization request within an authorizeService API request (or within a TA request network message). In some embodiments, the MCDE consists of three categories of data elements. The first category of data elements includes payment card information, which permits establishing the financial strength of the cardholder and of his or her payment account. The second category of data elements includes device information, which determines the level of trust in the device and/or server that will store the digital token and from which transactions will be triggered. The third category of data elements includes WP decision information, which allows the Issuer FI to evaluate other aspects of its' risk management policy concerning the WP customer's digital activity from a different perspective than that of a cardholder and/or payer. Thus, it may be that the set of data elements defined by a first WP for interfacing with MDES for providing risk management support to Issuers is different from the set of data elements defined by as second WP, which are required and/or defined by their own risk management policies.

Accordingly, based on the set of MCDE values it receives, an Issuer FI can decide whether or not to authorize the digitization of one of its cardholder's payment card accounts in a device and/or server that includes a particular type of operating system and storage type for the types of payment transactions proposed by the WP. The MDES requires an Issuer FI to provide a decision which either approves digitization, declines digitization, or requires additional authentication. Issuer FIs may also provide supplementary information and/or indications concerning the verification of the CVC2 code, and address verification matching (AVS—Address Verification Service). Based on the CVC2 matching result and/or of the address matching result, some WPs may require their consumers to provide further information or interactions, such as requesting a consumer to “Retype the CVC2” in order to complete a new digitization attempt.

It is clear that improvements to digital payment systems will continue to be developed over time (including the creation of new systems). Thus, each of the established wallet providers (WPs), token requestors (TRs) and their associated payment system environments may wish to enlarge the data elements of the MCDE with WPx Specific Data elements in one or more of the aforementioned categories (i.e., payment card information, device information, and WP decision information). In addition, new or additional WPs may emerge over the course of time, and each of these new entities may have their own requirements and/or their own data elements that they would like to transmit to Issuer FIs.

Referring again to FIG. 1, each Wallet Provider (WP) may wish to obtain onboarding of certain Issuer FI payment account ranges, and an Issuer FI's decision regarding whether or not to accept an offer from a particular WP may be based on a set of selection criteria. For example, an Issuer FI may wish to obtain information concerning what type of transactions (e.g., face-to-face and/or e-commerce) are supported by a particular WP, and may wish to know which type(s) of device and/or operating system (OS) are supported by that WP. Several combinations are extensively used at the present time, for example, Mobile Secure Element (SE) plus an operating system, Mastercard Cloud Based Payment (MCBP) plus an operating system, and Mastercard Trusted Based Payments (MTBP) in a Trusted Execution Environment (TEE) plus an operating system.

An Issuer FI may establish a preference for one or more Wallet Providers (WPs) based on information concerning the type(s) of security mechanisms utilized by that WP (i.e., based on trusted hardware such as a SE or TEE), or on trusted obfuscated software and white box cryptography (MCBP/Cloud). Other pertinent and/or required information may include how many of the Issuer's cardholders can adhere to the technology a WP supports (e.g., how many cardholders are equipped with Mobile Network Operator (MNO) Secure Element (SE)-based devices versus how many cardholders are equipped with secured software-based devices (such as Android-based smartphones). In addition, the Issuer FI may desire information concerning what type of technological possibilities are being offered by the WP for “dynamic” card recognition when digitizing a card. The Issuer FI may also require information concerning which types of cardholder verification methods (CVMs) are supported by the WP, such as, for example, fingerprint recognition, face recognition on the consumer's mobile device, use of a personal identification number (PIN) on a point-of-sale (POS) terminal, and the like.

Accordingly, during a digitization process in accordance with the present disclosure, the TSP computer system 102 may compile data elements based on the data received from a particular WP in a digitize command, and then add WPx-specific data. The TSP computer system 102 then transmits an authorizeService application programming interface (API) request to the Issuer FI associated with the consumer's payment card account. At this point in the process, the Issuer FI utilizes the data elements to decide whether to approve digitization, decline digitization, or require additional authentication information from the WP and/or cardholder. The received WPx-specific data may include supplementary information that can be used by the Issuer FI to come to a decision, and in some embodiments the Issuer FI can return WPx-specific reason codes. Thus, the Issuer FI transmits an authorizeService API response to the TSP computer system 102, which can include the CVC2 response, an AVS response, the actual decision (authorize or decline or request for authentication information). The TSP computer system 102 then transmits some or all of the data to the WP (which requested digitization) for further processing. For example, a CVC2 response may prompt the WP to request the cardholder to utilize his or her digital device to re-enter the CVC2 code in order to process another digitization attempt. The WP may also take advantage of any received WP-specific reason codes in order to provide decision information to, or request further data from, the cardholder. In some embodiments, the TSP computer system 102 provides each or the WPs (i.e., WP1 106A, WP2 106B to WPn 106n) with a list of WPx-Specific Reason Codes that depend on each WP's implementation features (for example, cloud-based with MCBP 2.0), which Issuer FIs may return when declining a digitization request. Such functionality allows the TSP computer system 102 to provide each of the WPs with customized information concerning the reason(s) for declining any particular digitization request. Such a process may help a WP to tailor the interactions with the cardholder or consumer resulting in a decrease in the rate of interrupted and/or failed digitization requests.

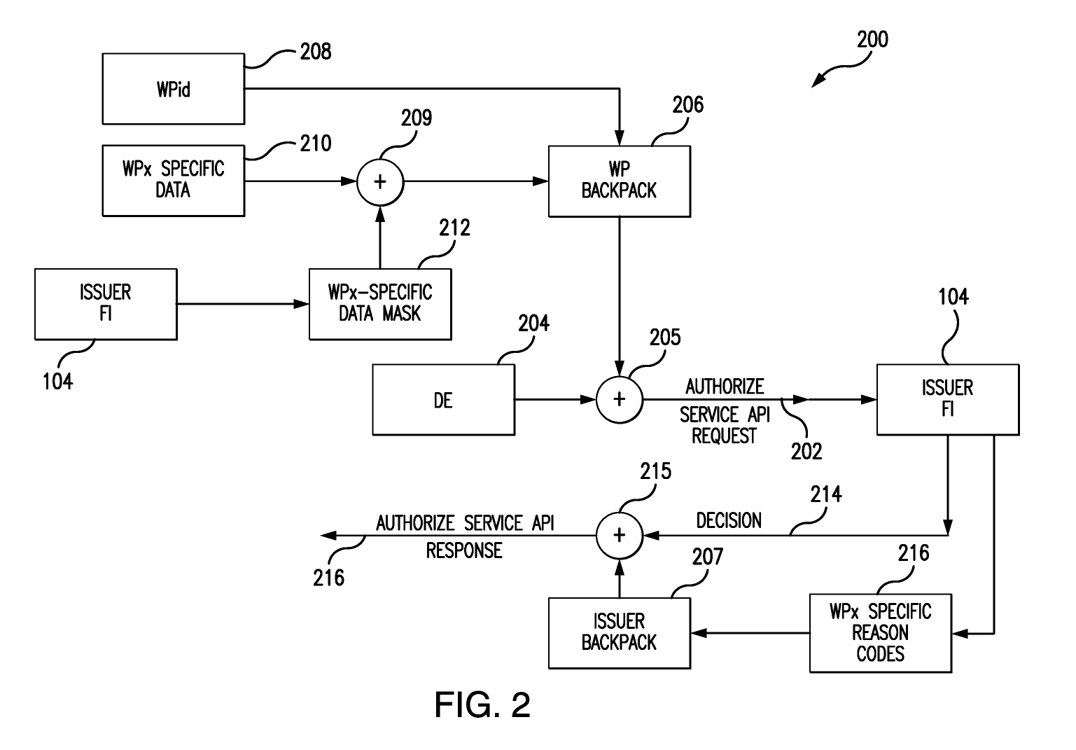

FIG. 2 is a flow diagram 200 illustrating a process for dynamically configuring an authorizeService request and an authorizeService response depending on Wallet Provider (WP) criteria and Issuer financial institution (FI) risk management policies in accordance with processes disclosed herein. In some embodiments, the TSP computer system receives a digitization request from a Wallet Provider (WP) concerning a consumer and the consumer's mobile device. The TSP computer system then configures the WP backpack 206 from a standard vector proposed by the WP, with a restricted set of components as chosen by the Issuer FI involved in that digitization. The standard vector includes data that reflects the “premium” offer of any particular WP for its' adherent Issuer FIs, and thus reflects that WP's latest achievements in security and risk assessment methods. In embodiments disclosed herein, a particular Issuer FI can restrict or filter the WP data by utilizing a mask. The Issuer FI may utilize two criteria when determining which WP data to use. In some implementations, the first criteria is whether or not one or more WP data element(s) is/are required for implementing the Issuer FI's risk management policy. In some embodiments, the second criteria is whether or not that Issuer FI is ready to process a particular type of WP data element. For example, a particular WP data element involves dynamic proof of card presence, which may be interesting for Issuer FI risk management purposes, but a particular Issuer FI may choose not to accept that WP data element because: a) based on the Issuer's consumer knowledge, a minimal number of cardholders are equipped with that type of device and operating system; and/or b) the Issuer realizes that there are higher priority development needs (in connection with that or other products) than that involved with that particular WP data element, and accordingly the Issuer resources needed to implement use of that particular WP data element are not available (i.e., the resources required may be too expensive for that Issuer FI to implement in order to utilize that WP data element).

The data structure of the Issuer backpack 207 may include a standard vector proposed by a particular WP that is populated at run time based on the set of data components it can provide, and may be limited by the Issuer FI's readiness to handle and/or process one or more of a particular WP's reason codes. The structure of the WP-specific reason codes data is defined during wallet onboarding with the TSP computer system. The standard vector reflects the “premium” offer of a particular WP reflecting its “user-friendliness” policy with regard to the guidance of consumers in the case wherein an Issuer FI declines the digitization attempt.

Referring again to FIG. 2, during operation the TSP computer system generates and then transmits 202 an authorizeService API request (digitization authorization request) to an Issuer FI computer 104. The authorizeService API request 202 is dynamically compiled at run-time, and the data load is also established at run-time. In some embodiments, the run-time data load includes a data element (DE) package 204, which may be a MCDE (Mastercard Data Element) package, whose data structure is fixed and known at run-time, but wherein the data element's values are established at run time. As also shown in FIG. 2, the DE package 204 is combined 205 with a WP data backpack 206.

The WP data backpack 206 is configured dynamically and thus established at run-time, and is populated with data element values computed at run-time. In this example implementation, the WP data backpack 206 includes a WP identifier (WPid) 208 of a specific Wallet Provider (WPx), which includes parameter values populated during the digitization with the consumer including data obtained from the consumer's mobile device. The WP data backpack 206 also includes a data structure configured during digitization consisting of the combination 209 of a WPx specific data package 210 (of the WPx engaged in the digitization of the consumer's payment account) and a WPx-specific data mask 212. Accordingly, the structure of the WP data backpack 206 is a variable vector which is compiled dynamically by the TSP computer system when forming the digitization request (the authorizeService API request), and includes a subset of specific data elements of the specific WPx.

The data elements of the WPx-specific data 210 can differ from one WP to another, and the process disclosed herein permits Issuer FIs to gradually improve the level of security of their individual digitization authorization decision process over time. Thus, each WPx provides their own private data elements (the WPx-specific data) during the onboarding process with the TSP computer system. In addition, the WPx-specific data mask 212 is provided by the Issuer FI, which includes mask values to associate with that WPx that were configured during the Issuer FI onboarding process. Thus, the Issuer FI 104 involved in the present digitization process, by use of the WPx-specific data mask 212, selects (out of the entire set of WPx-specific data) only that subset of data elements that serves the Issuer FI's risk management policies (and thus may also block some WPx-specific data when such data element(s) do not currently serve the Issuer FI's risk management policies). In future, however, the Issuer FI 104 can update or change the WPx-specific data mask 212 to allow one or more additional WPx-specific data element(s) to accommodate and updated security policy, for example, which may occur when additional resources are available that make it possible to use one or more of the additional WPx-specific data elements. Accordingly, the Issuer FI selects the desired subset of the WPx-specific data when onboarding an account range of consumer payment accounts for digitization for a given WPx, with a vector that includes Boolean components (for example, “Include” and “Do Not Include”), which is denoted as WPx-specific data mask 212. As mentioned above, an Issuer FI can later update or change the WPx-specific data mask 212 so that formerly excluded WP data elements are then included when, for example, changes are made by the Issuer FI to improve the level of security.

In some embodiments, after transmitting the authorizeService API request 202 to the Issuer FI, the TSP computer system receives an Issuer FI decision 214 consisting of a basic reporting package. The structure of the basic reporting package is fixed, and thus is known prior to the digitization transaction, and is common to all wallet providers (WPx). The basic reporting package consists of the Issuer FI's digitization decision (i.e., one of an approval, a decline, or a “require additional authentication” request) together with a cvcResponse and an aysResponse, which respectively indicates the results of the CVC2 verification and of the AVS verification (wherein the CVC2 and the AVS data has been provided by the consumer via the WPx during the digitization transaction).

Referring again to FIG. 2, the Issuer FI decision 214 is combined 215 with Issuer FI backpack data 207 (which a web service or host of the Issuer FI populates at run-time, or the time the digitization authorization response is formed). The Issuer FI backpack data 207 is a supplementary data package that corresponds to the specific reason codes of the specific Wallet Provider (WPx) engaged in the present digitization transaction, which is denoted as WPx-specific reason codes 216. The data elements of the WPx-specific reason codes 216 are defined by the WP during the onboarding process with the TSP computer system, and represent a differentiation factor between the different WPs. The WPx-specific reason codes are designed to help guide further consumer interactions when or if the Issuer FI declines the digitization request, or requires further authentication information. Thus, the authorizeService API response (or Tokenization Authorization (TA) network message) 216 may include one or more WPx-specific reason codes (which are available at the time of processing by the Issuer FI), and which may exclude one or more WPx-specific reason codes which are not available at the time of processing. Accordingly, the Issuer FI populates or determines the subset of WPx-specific reason codes that the Issuer FI is/are able to implement at run time, which reflects the level of development of their own web service.

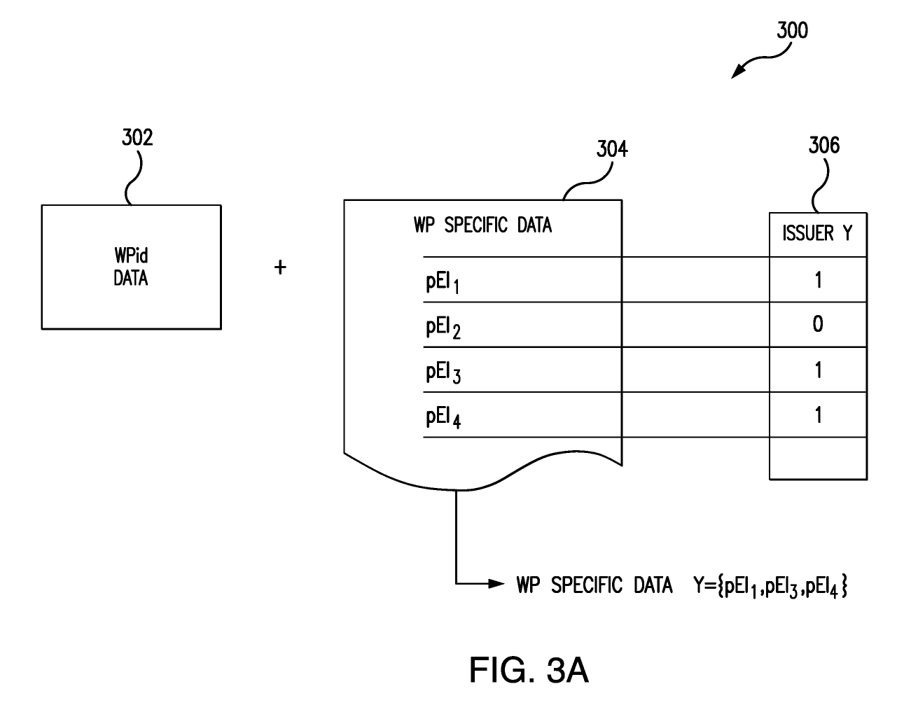

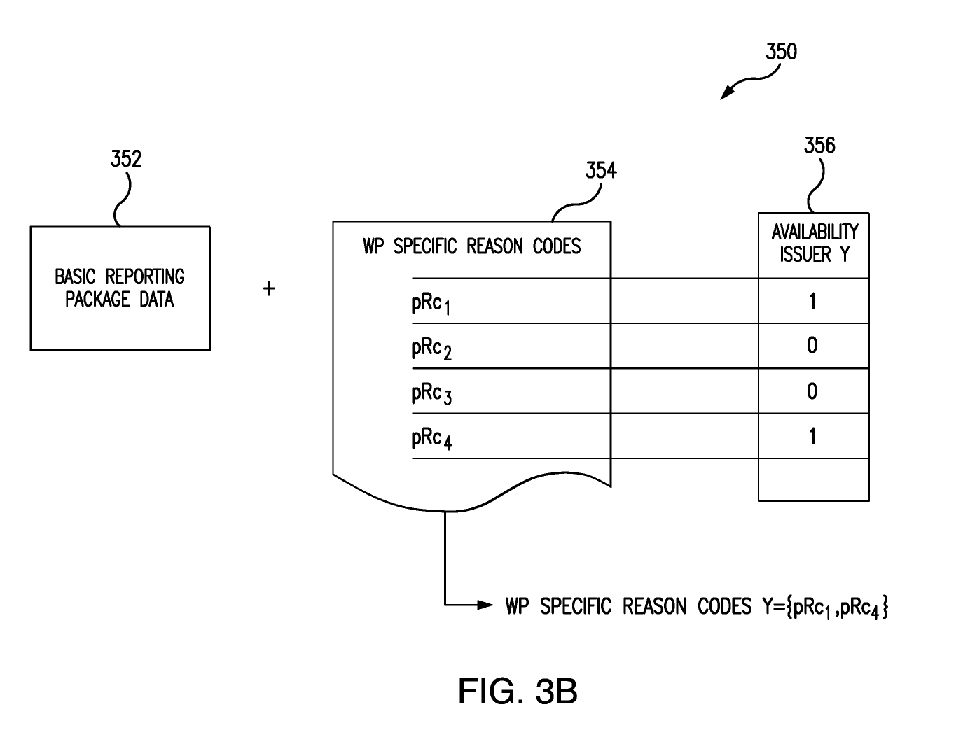

FIG. 3A is a functional block diagram 300 illustrating formation of the WP backpack, which is based on WPid data 302 and WP Specific data 304, wherein the WP Specific data 304 is formed by using an Issuer FI mask or vector 306 that is on-boarded by the issuer FI at an account range level. The WPid identifies the particular Wallet Provider. Thus, the formula for generating the WP backpack is as follows:

WP Backpack (x, y)=WPid concatenated with the WPx Specific Data y, where:
WPx Specific Data y=WPx Specific Data <AND> WPx Specific Data Mask y, for which:
   WPx Specific Data={pEl₁, pEl₂, . . . , pElₙ₍ₓ₎}, x=1, 2, . . . , k, with k=the number of Wallet Providers (WPs) in the program, and n(x)=the number of private elements (pEl's) for wallet provider x; pEl represents the private element for risk management proposed by the WP.
   WPx Specific Data Mask y={(0|1)₁, (0|1)₂, . . . ,(0|1)ₙ₍ₓ₎}, x=1, 2, . . . , k, with k=the number of WPs in the program, and n(x)=the number of private elements for wallet provider x; where “1” is set only for the WPx's data elements which the Issuer Y wants to use.

FIG. 3B is a functional block diagram 350 illustrating formation of the Issuer backpack based on Basic Reporting Package data 352 and WP Specific Reason codes 354. The web service or host of the Issuer FI populates the Issuer backpack at the time of forming the digitization authorization response with the specific reason codes of the WPx engaged in the digitization (denoted as “WPx Specific Reason Codes” herein). These data elements represent a differentiation factor between WPs, which can be used to guide the consumer interaction when the Issuer FI declines the digitization request. The WPx will onboard into the TSP computer the private elements of WPx Specific Reason Codes, and then the Issuer FI populates the subset that the Issuer is able to implement (at this certain moment in their web service development). Thus, the formula for obtaining the WP backpack is as follows:

Issuer Backpack (x)=Basic Reporting Package concatenated with the WPx Specific Reason Codes.

As noted above, the Basic reporting package has a fixed structure that is common to all WPs, and is known before the digitization transaction. The Basic Reporting Package consists of the Issuer FI decision (approve or decline or require additional authentication) together with the cvcResponse and aysResponse, indicating the results of the CVC2 verification and of the AVS verification. In addition, as shown in FIG. 3B, the WPx Specific Reason Codes in this example are equal to only “pRc1” and “pRc4” because “pRc2” and “pRc3” are not available at time of processing.

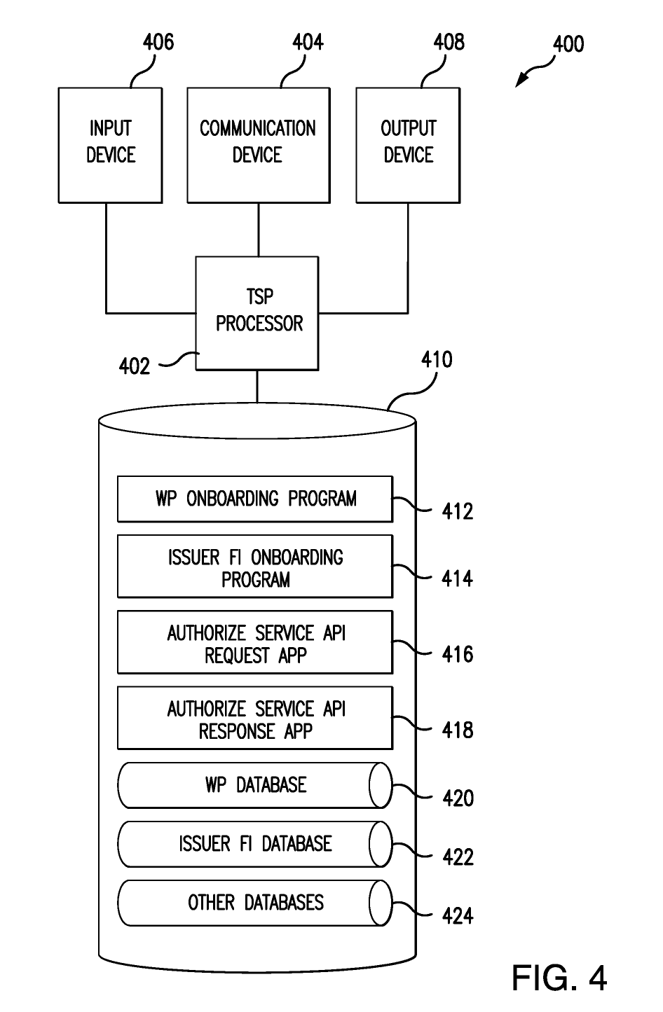

FIG. 4 is a block diagram that illustrates an example embodiment of a TSP computer system 400 that embodies at least part of the functionality of TSP computer system 102 (FIG. 1) and which may be utilized in accordance with aspects of the present disclosure. The TSP computer system 400 may include standard components and/or custom-designed and/or proprietary components in terms of its hardware and/or architecture, and may be controlled by software to cause it to function as described herein. For example, the TSP computer system 400 may include server computer hardware.

The TSP computer system 400 may include a TSP processor 402 operatively coupled to a communication device 404, an input device 406, an output device 408, and a storage device 410. The TSP processor 402 may be constituted by one or more processors, and operates to execute processor-executable steps, contained in program instructions described below, so as to control the TSP computer system 400 to provide desired functionality.

Communication device 404 may be used to facilitate communication with, for example, other devices (such as Wallet Provider (WP) computers and Issuer FI computers as depicted in FIG. 1). For example, communication device 404 may comprise numerous communication ports (not separately shown), to allow the TSP computer system 400 to communicate simultaneously with a number of other computers and other devices, including communications as required to simultaneously handle numerous requests for digitization of consumer payment accounts. Thus, the communication device 404 may be configured for wireless communications and/or wired communications via various different types of networks, such as the Internet.

Input device 406 may comprise one or more of any type of peripheral device typically used to input data into a computer. For example, the input device 406 may include a keyboard and a mouse. Output device 408 may include, for example, a display and/or a printer. In some embodiments, the input device 406 and the output device 408 comprise a touch screen.

Storage device 410 may include any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, solid-state drive (SSD) devices, as well as volatile and/or non-volatile flash memory and the like. Any one or more of such information storage devices may be considered to be a non-transitory computer-readable storage medium or computer usable medium or memory.

Storage device 410 stores one or more computer programs for controlling the TSP processor 402. The programs comprise program instructions (which may be referred to as computer readable program code means) that contain processor-executable process steps of the TSP computer system 400, executed by the TSP processor 402 to cause the TSP computer system 400 to function as described herein.

The programs may include one or more conventional operating systems (not shown) that control the TSP processor 402 to manage and coordinate activities and sharing of resources in the TSP computer system 400, and to serve as a host for application programs that run on the TSP computer system 400.

The storage device 410 may store a WP onboarding program 412 and an Issuer FI onboarding program 414, which include instructions configured to cause the TSP processor 402 to provide onboarding (or registration) of Wallet Providers (WPs) and Issuer FIs, respectively. Also included are an authorizeService Application Programming Interface (API) request application 416, and an authorizeService API response application 418 to enable processing of payment account digitization requests by consumers via their WPs (utilizing WP-specific data and the like), and to enable reporting of Issuer FI digitization decisions, respectively, in a manner as described herein.

The storage device 410 may also store, and the TSP computer system 400 may also execute, other programs and/or applications, which are not shown. Such other programs and/or applications may also include, e.g., one or more data communication programs, database management programs, device drivers, etc.

The storage device 410 may also store a WP database 420 and an Issuer FI database 422, which store registration data and other data specific to each WP and/or Issuer FI. Such WP and Issuer databases may include, for example, a list of WP identifiers and a list of Issuer FI identification numbers (e.g., PAN-length BINs), respectively, along with other data needed for the TSP computer system 400 to properly generate and transmit both an authorizeService API request message and an authorizeService API response message. The storage device 410 may also include one or more databases 424 required for operation of the TSP computer system 400.

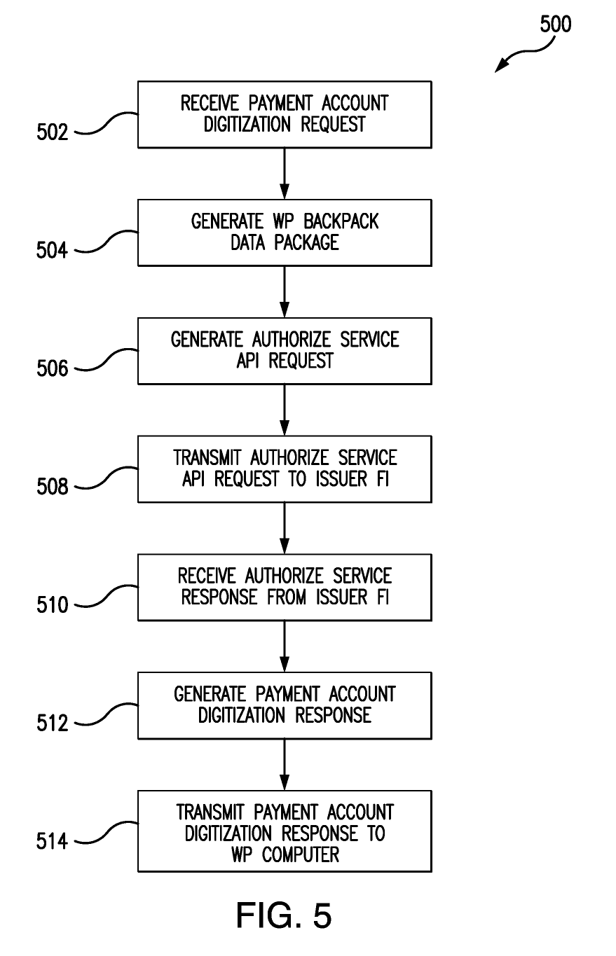

FIG. 5 is a flowchart illustrating a payment account digitization process 500 according to some embodiments of the disclosure. A Trusted Services Provider (TSP) computer receives 502 a consumer payment account digitization request from a registered Wallet Provider (WP) computer. In some implementations, the consumer payment account digitization request includes WP identification data, WP load data and WP-specific data. Next, the TSP computer generates 504 a WP backpack data package by combining the WP load data with data resulting from a combination of WP-specific data and a WP-specific data mask. The WP-specific data mask is provided by a registered Issuer financial institution (FI) computer of an Issuer FI, wherein the Issuer FI issued the consumer's payment account.

Referring again to FIG. 5, the TSP computer next generates 506 an authorizeService application program interface (API) request by combining the WP backpack data package with TSP data elements. The TSP computer then transmits 508 the authorize service API request to the Issuer FI computer for consumer payment account digitization authorization processing. Next, the TSP computer receives 510 an authorize service response from the Issuer FI computer. In some embodiments, the authorize service response includes basic reporting package data and, if the Issuer FI decision is to decline digitization of the payment account, WP-specific reason codes (the WP-specific reason codes are associated with decline determinations from the Issuer FI computer, and in some implementations, were defined during a WP onboarding process). In some embodiments, the basic reporting package data includes the authorization decision, a CVC verification indication, and an AVS verification indication. Referring to FIG. 5, the TSP computer then generates 512 a Payment Account Authorization Response, which includes Issuer backpack data, and transmits 514 the Payment Account Authorization Response to the WP computer.

The flow chart(s) and/or data flow diagrams, and descriptions thereof herein, should not be understood to prescribe a fixed order of performing the method steps and/or processes described therein. Rather, the method steps and/or process steps may be performed in any order that is practicable. In addition, the flow chart(s) and/or data flow diagrams described herein should not be understood to require that all steps or elements be practiced in every embodiment. For example, one or more elements or steps may be omitted in some embodiments.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

As used herein, the terms “coupled” and “operably connected” may be used. The term “coupled” may be used to indicate that two or more elements, which may or may not be in direct physical or electrical contact with each other, co-operate or interact with each other. The term “operably connected” may be used to indicate the establishment of communication between two or more elements that are coupled with each other.

The term “server computer” relates to a powerful computer or combination of two or more computers. For example, a server computer can be a mainframe computer, a minicomputer cluster, or a group of servers functioning as a unit such as a cluster. In one example, the server computer may be a database server coupled to a web server. Server computers often execute server applications that act as a server in client-server interactions, including but not limited to database server applications, web server applications, application server applications, and the like.

As used herein, a “communications channel” may refer to any suitable path for communication between two or more entities. Suitable communications channels may be present directly between two entities such as a payment processing network and an Issuer FI computer or a WP computer, or may include a number of different entities. Any suitable communications protocols may be used for generating a communications channel, and in some cases a communication channel may be a “secure communication channel,” which may be established in any known manner, including the use of mutual authentication and a session key and establishment of a Secure Sockets Layer (SSL) session. By establishing a secure channel, sensitive information related to a payment device (such as account number, Card Verification Value (CVV) values, expiration dates, and the like) may be securely transmitted between the two entities to facilitate a transaction.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A payment account digitization process comprising:
receiving, by a Trusted Services Provider (TSP) computer from a registered Wallet Provider (WP) computer, a digitization request associated with a consumer payment account, the digitization request comprising WP identification data, WP load data, and WP-specific data;
generating, by the TSP computer, a WP backpack data package by combining the WP identification data, the WP load data, and data resulting from a combination of WP-specific data and a WP-specific data mask, wherein the WP-specific data mask is associated with an Issuer financial institution (FI) that issued the consumer payment account;
generating, by the TSP computer, an authorizeService application program interface (API) request by combining the WP backpack data package with TSP data elements; and
transmitting, by the TSP computer, the authorizeService API request to an Issuer FI computer associated with the Issuer FI that issued the consumer payment account for digitization authorization processing.

2. The method of claim 1, further comprising:
receiving, by the TSP computer from the Issuer FI computer, an authorize service response comprising basic reporting package data and a digitization decision;
generating, by the TSP computer, a payment account digitization response based on the basic reporting package data and the digitization decision; and
transmitting, by the TSP, the payment account digitization response to the WP computer.

3. The method of claim 2, wherein the basic reporting package data comprises an authorization decision indication, a CVC verification indication, and an AVS verification indication.

4. The method of claim 2, wherein the digitization response comprises a digitization decline decision and further comprising, prior to generating the payment account digitization response:
forming, by the TSP computer, an Issuer backpack data package by concatenating at least one WP-specific decline reason code with the basic reporting package; and
transmitting, by the TSP computer, a payment account digitization response to the WP computer comprising the at least one WP-specific decline reason code and the basic reporting package.

5. The method of claim 2, further comprising, prior to generating the payment account digitization response:
receiving, by the TSP computer from the Issuer FI computer, a request for additional authentication information;
generating, by the TSP computer, a payment account digitization response by combining the request for additional authentication information with the basic reporting package data; and
transmitting, by the TSP, the payment account digitization response to the WP computer.

6. The method of claim 1, wherein the digitization request further comprises payment card account identification data and consumer device identification data.

7. The method of claim 1, wherein the WP-specific data comprises at least one of information identifying at least one type of security mechanism utilized by the WP, and information identifying at least one cardholder verification methods (CVM) supported by the WP.

8. The method of claim 1, wherein the WP-specific data mask comprises a list of WP data elements suitable for use by the Issuer FI computer.

9. The method of claim 1, wherein the WP backpack data package is dynamically compiled at runtime.

10. A Trusted Service Provider (TSP) computer system, comprising:
a TSP processor;
a communication device operably connected to the TSP processor; and
a storage device operably connected to the TSP processor, wherein the storage device comprises instructions configured to cause the TSP processor to:
receive, via the communications device from a registered Wallet Provider (WP) computer, a digitization request associated with a consumer payment account, the digitization request comprising WP identification data, WP load data, and WP-specific data;
generate a WP backpack data package by combining the WP identification data, the WP load data, and data resulting from a combination of WP-specific data and a WP-specific data mask, wherein the WP-specific data mask is associated with an Issuer financial institution (FI) that issued the consumer payment account;
generate an authorizeService application program interface (API) request by combining the WP backpack data package with TSP data elements; and
transmit, via the communications device to an Issuer FI computer associated with the Issuer FI that issued the consumer payment account, the authorize service API request to for digitization authorization processing.

11. The TSP computer system of claim 10, wherein the storage device further comprises instructions configured to cause the TSP processor to:
receive, via the communications device from the Issuer FI computer, an authorize service response comprising basic reporting package data and a digitization decision;
generate a payment account digitization response based on the basic reporting package data and the digitization decision; and
transmit, via the communications device, the payment account digitization response to the WP computer.

12. The TSP computer system of claim 11, wherein the basic reporting package data comprises an authorization decision indication, a CVC verification indication, and an AVS verification indication.

13. The TSP computer system of claim 11, wherein the digitization response comprises a digitization decline decision, and wherein the storage device further comprises instructions, prior to the instructions for generating the payment account digitization response, configured to cause the TSP processor to:
form an Issuer backpack data package by concatenating at least one WP-specific decline reason code with the basic reporting package; and
transmit, via the communications device, a payment account digitization response to the WP computer comprising the at least one WP-specific decline reason code and the basic reporting package.

14. The TSP computer system of claim 11, wherein the storage device further comprises, prior to the instructions for generating the payment account digitization response, instructions configured to cause the TSP processor to:
receive, via the communications device from the Issuer FI computer, a request for additional authentication information;
generate a payment account digitization response by combining the request for additional authentication information with the basic reporting package data; and
transmit the payment account digitization response to the WP computer.

15. The TSP computer system of claim 10, wherein the digitization request further comprises payment card account identification data and consumer device identification data.

16. The TSP computer system of claim 10, wherein the WP-specific data comprises at least one of information identifying at least one type of security mechanism utilized by the WP, and information identifying at least one cardholder verification method (CVM) supported by the WP.

17. The TSP computer system of claim 10, wherein the WP-specific data mask comprises a list of WP data elements suitable for use by the Issuer FI computer.

18. The TSP computer system of claim 10, wherein the WP backpack data package is dynamically compiled at runtime.
